(19) United States
(12) Patent Application Publication
(10) Pub. No.: US 2024/0196313 A1
(43) Pub. Date: Jun. 13, 2024

(54) ENHANCED DELAY STATUS REPORT (DSR) FOR LOW LATENCY (LL) FRAMES

(71) Applicant: NXP USA, Inc., Austin, TX (US)

(72) Inventors: Kiseon Ryu, San Diego, CA (US); Liwen Chu, San Ramon, CA (US); Hongyuan Zhang, Fremont, CA (US)

(21) Appl. No.: 18/504,907

(22) Filed: Nov. 8, 2023

Related U.S. Application Data
(60) Provisional application No. 63/386,944, filed on Dec. 12, 2022.

(51) Int. Cl. H04W 48/16; H04L 5/00

(52) U.S. Cl. CPC H04W 48/16; H04L 5/0048

(57) ABSTRACT

One example discloses a method of low-latency (LL) frame management for communications between a first WLAN (wireless local area network) device and a second WLAN device, including: transmitting, by the first WLAN device, a low-latency (LL) specific delay status report (DSR) trigger frame to the second WLAN device; and receiving, by the AP, a DSR frame from the second WLAN device in response to the LL specific DSR trigger frame.

### REFERENCE TO PROVISIONAL APPLICATION TO CLAIM PRIORITY

A priority date for this present U.S. patent application has been established by prior U.S. Provisional Patent Application, Ser. No. 63/386,944, entitled “Delay status report for low latency traffic”, filed on Dec. 12, 2022, and commonly assigned to NXP USA, Inc.

The present specification relates to systems, methods, apparatuses, devices, articles of manufacture and instructions for enhancing Delay Status Reports (DSR) for Low Latency (LL) frames.

### SUMMARY

According to an example embodiment, a method of low-latency (LL) frame management for communications between a first WLAN (wireless local area network) device and a second WLAN device, comprising: transmitting, by the first WLAN device, a low-latency (LL) specific delay status report (DSR) trigger frame to the second WLAN device; and receiving, by the AP, a DSR frame from the second WLAN device in response to the LL specific DSR trigger frame.

In another example embodiment, the first WLAN device is an AP (access point) and the second WLAN device is a non-AP STA (station).

In another example embodiment, the second WLAN device is a non-AP STA configured for direct peer-to-peer (P2P) communication with another non-AP STA.

In another example embodiment, the LL specific DSR trigger frame is a modified NFRP (NDP Feedback Report Poll) trigger frame.

In another example embodiment, the NFRP trigger frame includes an AID12 subfield set to a specific value or to an AID of the non-AP STA; and if the non-AP STA has buffered LL frames, then the non-AP STA is configured set the DSR frame to true in response to the AID12 subfield set to the specific value or set to the AID of the non-AP STA.

In another example embodiment, the non-AP STA is configured to include an indication whether a HOL (head of line) packet enqueue time exceeds or does not exceed a certain threshold time in the DSR frame.

In another example embodiment, the non-AP STA is configured to include an indication whether a HOL (head of line) packet expiration time is less than or larger than a certain threshold in the DSR frame.

In another example embodiment, the LL specific DSR trigger frame is a BSRP (Buffer Status Report Poll) trigger frame.

In another example embodiment, the non-AP STA is configured to indicate a presence of buffered LL frames in the DSR frame; and the AP is configured to allocate a set of resource units (RUs) to the non-AP STA for transmission of the buffered LL frames.

In another example embodiment, the BSRP trigger frame includes a subfield indicating a poll of delay status report for prompting the non-AP STA to indicate the presence of buffered LL frames.

In another example embodiment, the BSRP trigger frame includes a subfield indicating a direction of a traffic stream for prompting the non-AP STA to indicate a direction of the buffered LL frames.

In another example embodiment, the DSR frame from the non-AP STA includes a QoS (quality of service) Null frame; and the QoS Null frame includes delay status information on the buffered LL frames.

In another example embodiment, the QoS null frame includes at least one of: a traffic identifier (TID); a head of line (HOL) packet delay; a queue size of the TID; or a direction information indicating an uplink or a direct link.

In another example embodiment, further comprising adding a DSR control field to the DSR frame for reporting on buffered low-latency (LL) frame.

In another example embodiment, the DSR control field includes an indication of a direction of a traffic stream associated with reported delay status information.

In another example embodiment, the set of DSR control field is embedded in a QoS (quality of service) Null frame.

In another example embodiment, the DSR control field includes a set of delay bound subfields.

In another example embodiment, the DSR control field includes a medium time request subfield.

In another example embodiment, the DSR control field includes an urgent delay bound.

In another example embodiment, the DSR frame includes a control field for indicating whether the non-AP STA's buffered LL frames are uplink (UL) frame or direct/P2P link frames.

According to an example embodiment, an access point (AP) configured to communicate over a WLAN (wireless local area network) network, comprising: a controller configured to transmit a low-latency (LL) specific delay status report (DSR) trigger frame requesting a DSR frame from a non-AP STA over the WLAN network; wherein the controller is further configured to receive the DSR frame from the non-AP STA.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents a first example wireless communications network (WLAN).

FIGS. 2A, 2B, 2C represents an example trigger frame format, an example common info field, and an example trigger type subfield encoding.

FIG. 3 represents an example delay status report (DSR) transmitted unsolicited or in response to a BSRP (buffer status report poll) trigger frame.

FIG. 4 represents a first example of adding a set of DSR control elements to a DSR response frame for reporting on buffered low-latency (LL) frames.

FIGS. 5A, 5B represents a second example of adding a set of DSR control fields to a DSR response frame for reporting on buffered low-latency (LL) frames.

FIG. 6A, 6B, 6C, 6D, 6E, 6F represents a third example of adding a set of DSR control fields to a DSR response frame for reporting on buffered low-latency (LL) frames.

FIGS. 7A, 7B represents a fourth example of adding a set of DSR control fields to a DSR response frame for reporting on buffered low-latency (LL) frames.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

IEEE (Institute of Electrical and Electronics Engineers) 802 defines communications standards for various networked devices (e.g., Local Area Networks (LAN), Metropolitan Area Networks (MAN), etc.). IEEE 802.11 further defines communications standards for Wireless Local Area Networks (WLAN). As such, communications on these networks must, by agreement, follow one or more communications protocols (i.e. be standards compliant) so that various network devices can communicate. These protocols are not static and are modified (e.g., different generations) over time, typically to improve communications robustness and increase throughput.

In embodiments of a wireless communication network described below, a wireless communications device such as an access point (AP) of a wireless local area network (WLAN) transmits data streams to one or more client stations (STAs). The AP and STAs communicate using one or more communication protocols. These protocols may include IEEE protocols such as: 802.11b; 802.11g; 802.11a; 802.11n [i.e. HT (High Throughput) with Single-User Multiple-Input Multiple-Output (SU-MIMO)]; 802.11ac [i.e. VHT (Very High Throughput) with downlink Multi-User MIMO (MU-MIMO)]; 802.11ax [i.e. HE (High Efficiency) operating at both 2.4- and 5-GHz bands, including OFDMA (Orthogonal Frequency Division Multiple Access) and MU-MIMO with uplink scheduling]; and 802.11be [i.e. EHT (Extra High Throughput) operating at 2.4 GHz, 5 GHZ, and 6 GHz frequency bands and a much wider 320 MHz bandwidth].

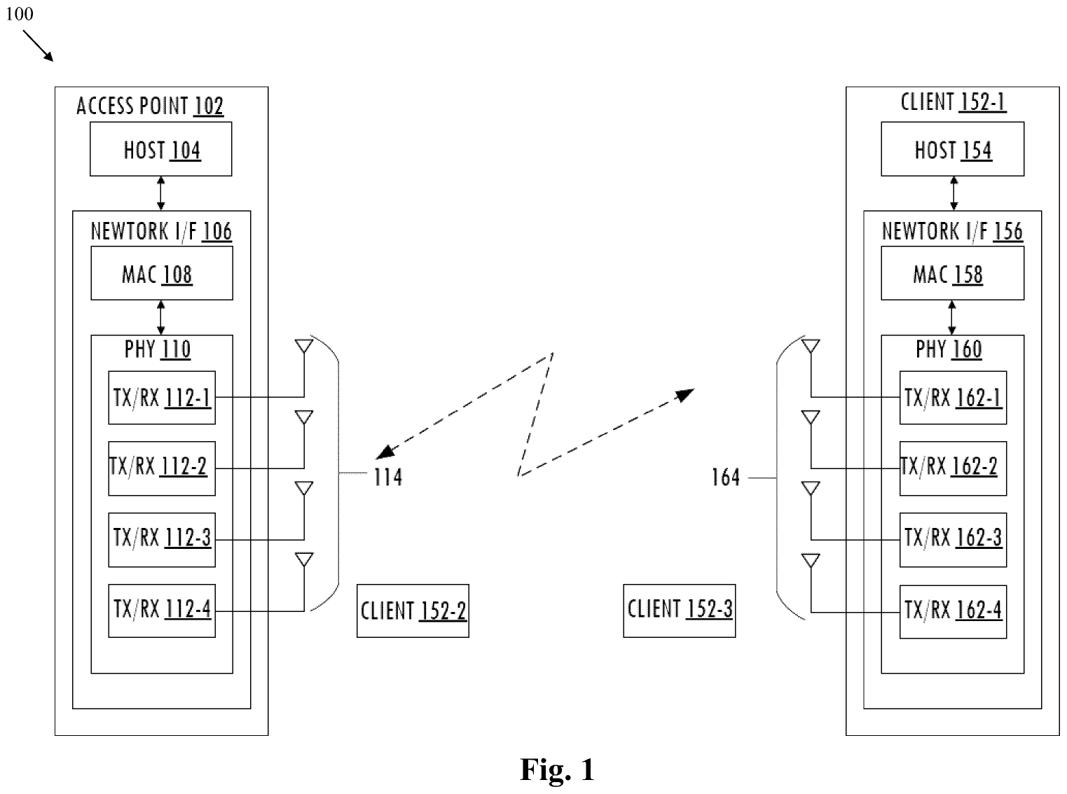

FIG. 1 represents a first example 100 wireless communications network (WLAN) formed by a first set of wireless communications devices (i.e. AP STAs and Client-STAs). The WLAN 100 includes access point station (AP STA) 102 and a set of non-AP stations (non-AP/Client STAs) 152-1, 152-2, and 152-3.

The AP 102 includes host processor 104 (e.g., controller) coupled to network interface 106. Host processor 104 includes a processor configured to execute machine readable instructions stored in a memory device (not shown), e.g., random access memory (RAM), read-only memory (ROM), a flash memory, or other storage device.

Network interface 106 includes medium access control (MAC) processor 108 and physical layer (PHY) processor 110. In some example embodiments the MAC processor 108 operates at the data-link layer of the OSI (Open Systems Interconnection) model and the PHY processor 110 operates at the physical layer of the OSI model.

The PHY processor 110 includes a plurality of transceivers 112-1, 112-2, 112-3, and 112-4, each of which is coupled to a corresponding antenna of antennas 114. These antennas 114 can support MIMO functionality. Each of transceivers 112-1, 112-2, 112-3, and 112-4 includes a transmitter signal path and a receiver signal path, e.g., mixed-signal circuits, analog circuits, and digital signal processing circuits for implementing radio frequency and digital baseband functionality. The PHY processor 110 may also include an amplifier (e.g., low noise amplifier or power amplifier), a data converter, and circuits that perform discrete Fourier transform (DFT), inverse discrete Fourier transform (IDFT), modulation, and demodulation, thereby supporting OFDMA modulation.

The client STAs 152-1, 152-2, and 152-3 each include similar circuits (e.g., host processor 154 (e.g., controller), network interface 156, MAC processor 158, PHY processor 160, transceivers 162-1, 162-2, 162-3, and 162-4, and antennas 164) that provide similar functionality to that of AP 102 but are adapted to client-side specifications.

The MAC 108, 158 and PHY 110, 160 processors within the AP 102 and STA 152-1 exchange PDUs (Protocol Data Units) and SDUs (Service Data Units) in the course of managing the wireless communications traffic. The PHY processor is configured to receive MAC layer SDUs, encapsulate the MAC SDUs into a special PDU called a PPDU (physical layer protocol data units) by adding a preamble.

The preamble (i.e. TXVECTOR, transmission vector) specifies the PPDU's transmission format (i.e. which IEEE protocol (e.g., EHT, HE, etc.) has been used to pack the SDU data payload). The PPDU preambles may include various training fields (e.g., predetermined attributes) that are used by the receiving APs or STAs to perform synchronization, gain control, estimate channel characteristics, and signal equalization. The AP 102 and STA 152-1 then exchange the PPDU formatted wireless communications signals 116.

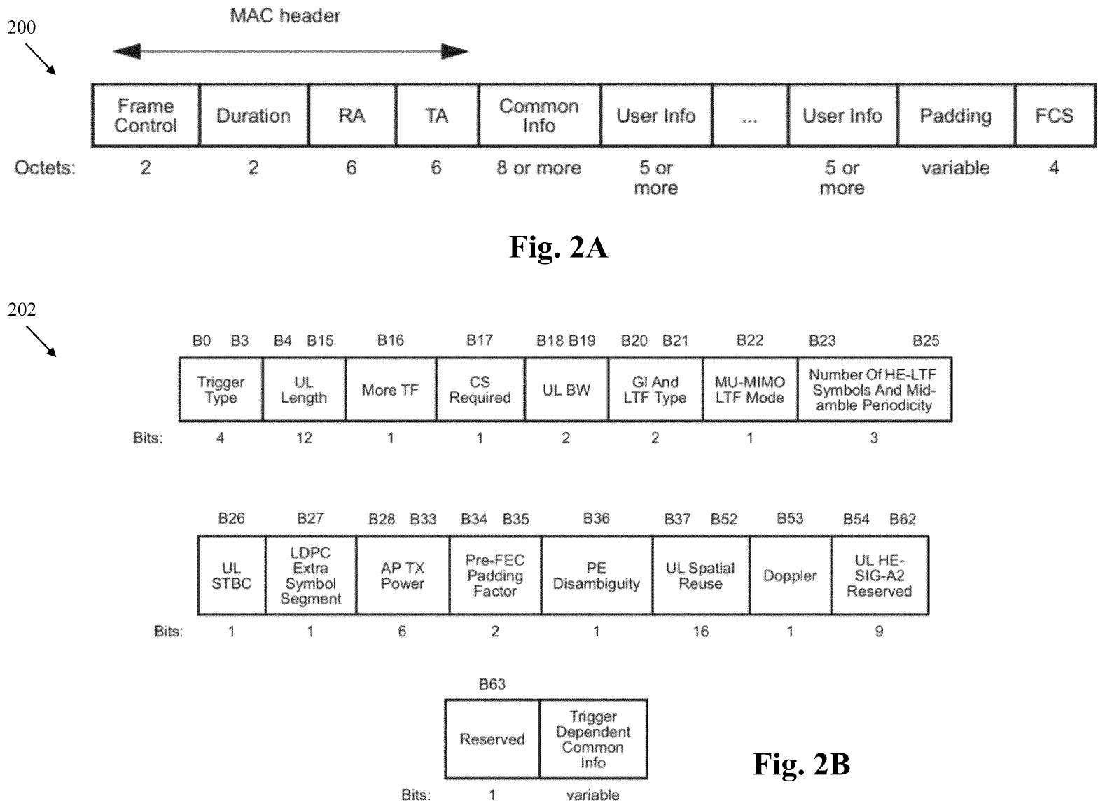

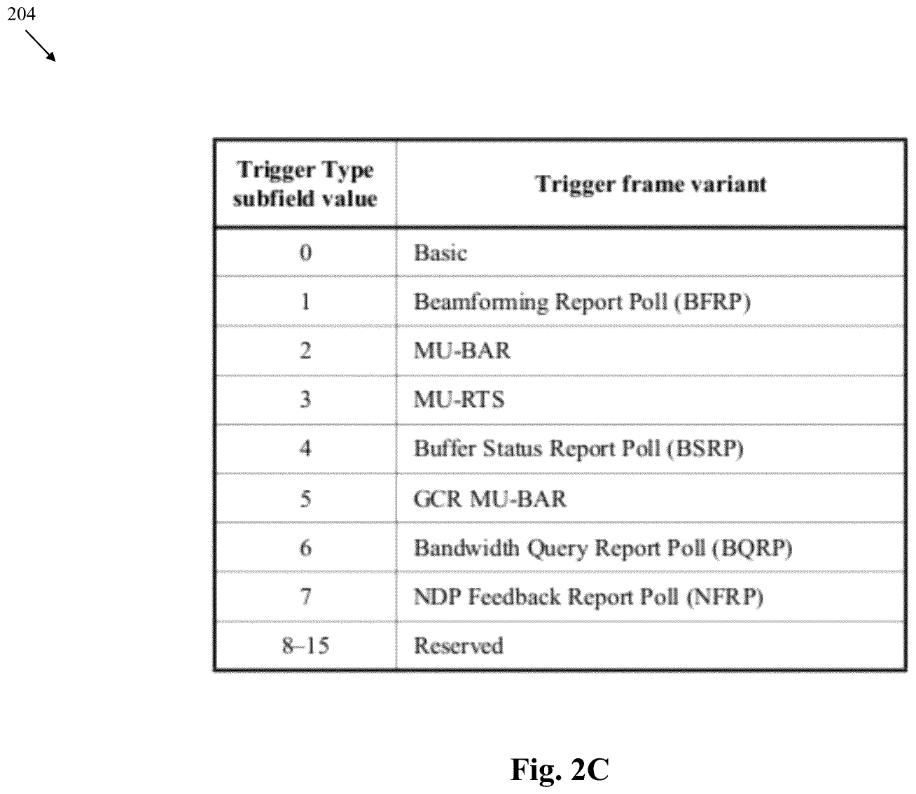

FIGS. 2A, 2B, 2C represent an example trigger frame format 200, an example common info field 202, and an example trigger type subfield encoding 204. Current versions and novel modified versions of these trigger frames supporting low-latency (LL) traffic communications between various WLAN (wireless local area network) devices are now discussed.

Low-latency (LL) frames waiting to be transmitted from non-AP STAs (e.g. uplink traffic) or between non-AP STAs (e.g. direct/peer-to-peer (P2P) traffic) are required to be transmitted before they are expired.

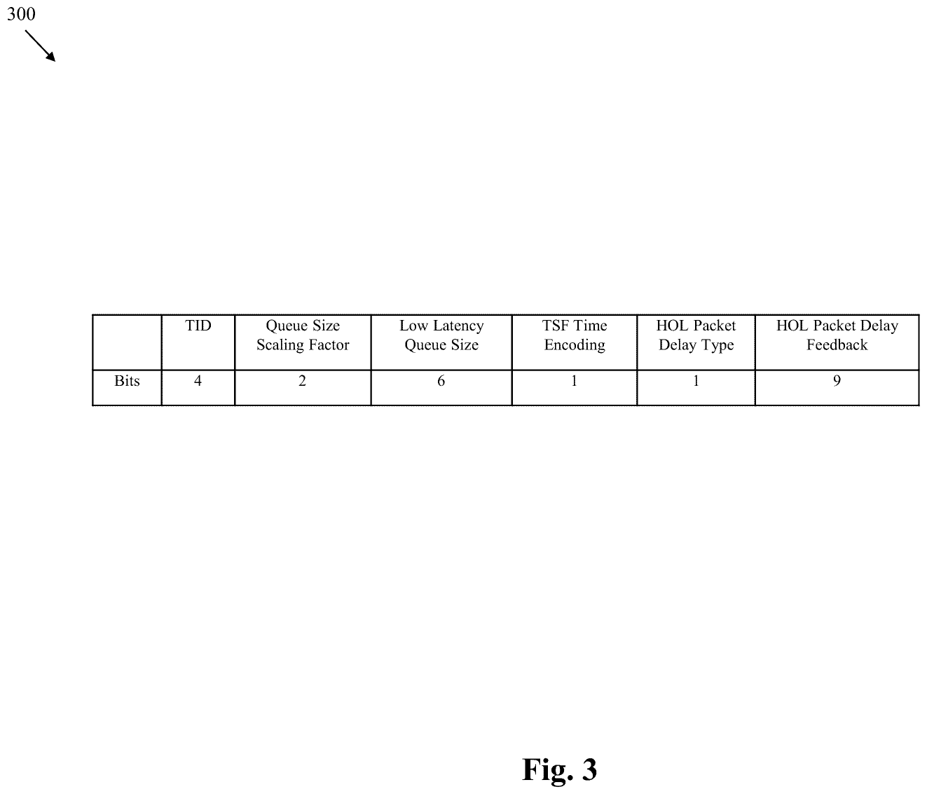

FIG. 3 represents an example 300 delay status report (DSR)) transmitted unsolicited or in response to a BSRP (buffer status report poll) trigger frame. This example 300 DSR is defined in IEEE 802.11-22/1454. Here an AP can transmit a BSRP trigger frame that requests from various non-AP STAs in a BSS (basic service set) for a DSR report on their buffered uplink frames.

The DSR may include a TID (traffic identifier); a queue size of the buffered frames identified by TID field; and a TSF (timing synchronization function) time when a HOL frame (Head-of-Line (HOL) frame) of the TID is received at the local MAC SAP, or a TSF Time when the HOL frame reaches its delay bound.

This DSR however often does not meet the needs of LL frames transmission, resulting in delayed/expired LL frames that may cause various WLAN network disruptions, particularly for uplink and P2P LL frames.

For example, Head-Of-Line (HOL) blocking can degrade the WLAN network's performance by forcing a STA to remain in a back-off stage for a long time due to the HOL blocking the LL frames. IEEE 802.11-22/1454 also does not address direct/P2P communications between STAs.

A non-AP STA may deliver delay status reports (DSRs) in addition to the BSR to assist its AP in allocating UL MU resources.

When reporting the DSR, the non-AP STA can set the TID, Queue Size Scaling Factor, Low Latency Queue Size subfields, and can set the HOL Packet Delay Feedback subfield in the DSR Control subfield to TSF (timing synchronization function) [Bit S:Bit S+8], where TSF corresponds to the HOL packet enqueue (i.e. in the queue) time when the HOL Packet Delay Type subfield is set to 0 or the HOL packet expiration time when the HOL Packet Delay Type subfield is set to 1.

The TSF timer at which the HOL packet was enqueued or will expire, when the HOL Packet Delay Type subfield is set to 0 or 1, respectively, has bits 0 to S−1 equal to zero and bits S+9 to 63 equal to the same value as the respective bits in the current TSF timer.

The non-AP STA that reports DSR may set the Low Latency Queue Size subfield to be less than or equal to the total size of all the MAC service data units (MSDUs) and A-MSDUs buffered in the TID. The HOL Packet Delay Type subfield value of 1 can only be used for the traffic of an established SCS stream with its EHT AP and which include a non-zero value in the Delay Bound field of the QoS Characteristics element with the Direction subfield set to 1 (Uplink).

Now discussed are various example embodiments for enabling non-AP STAs to generate low-latency (LL) specific delay status reports (DSRs) thereby providing more information about their buffered/queued low-latency (LL) frames.

Some example embodiments include: generating a low-latency (LL) specific DSR using a modified NFRP (NDP Feedback Report Poll) trigger frame; generating a low-latency (LL) specific DSR using a BSRP (Buffer Status Report Poll) trigger frame; and adding a set of DSR control elements to a DSR response frame for reporting on buffered low-latency (LL) frames.

### Generating a Low-Latency (LL) Specific DSR Using an NFRP (NDP Feedback Report Poll) Trigger Frame

Current NFRP (null data packet feedback report poll) trigger frames are defined in draft P802.11REVme D2.0. This current NFRP trigger frame enables an HE AP to collect feedback that is not channel sounding from multiple non-AP HE STAs. An HE AP sends an NFRP (NDP Feedback Report Poll) trigger frame to solicit a NFRP response from the non-AP STAs that are identified within a range of scheduled AIDs (association IDs), wherein each of these non-AP STAs within the BSS has a unique AID. The NFRP response is an HE TB feedback NDP (see 27.3.18 (HE TB feedback NDP)). Non-AP STAs use the information carried in the NFRP trigger frame to know when to transmit their NFRP response. If the Feedback Type subfield in the User Info field of the NFRP Trigger frame is 0, a STA that is scheduled may send an NDP feedback report response in order to signal to the AP that it is in the awake state and that it might have frames in its queues for UL MU. Each STA that is scheduled is assigned a STARTING_STS_NUM and an RU_TONE_SET_INDEX to transmit a FEEDBACK_STATUS bit set to either a value 0 indicating that the STA is in the awake state and reports buffered octets for transmission not exceeding the resource request buffer threshold, or a value 1 indicating that the STA is in the awake state and reports buffered octets for transmission exceeding the resource request buffer threshold.

Now presented are various example embodiments of the modified NFRP trigger frame that are specifically tailored for checking if any non-AP STA has a buffered low-latency (LL) frame. To poll non-AP STA's low-latency frames requirement, the AP transmits a modified NFRP (NDP Feedback Report Poll) trigger frame that is tailored to low-latency frames reporting.

In some example embodiments, an AID12 subfield in the NFRP trigger frame set to a specific value (e.g., 2044, or 2047, etc.). A non-AP STA that has buffered low-latency frames and receives the NFRP trigger frame with the AID12 set to the specific value, responds by transmitting an NDP feedback (i.e. the NFRP response frame) set to true.

If an AP receives the NDP feedback set to true from any non-AP STA, the AP then transmits a TF-R frame allocating RA RUs to the non-AP STA for transmitting the buffered LL frames.

In other example embodiments, an AID12 subfield in the NFRP trigger frame is set to an AID of a non-AP STA. The non-AP STA that has a buffered low-latency frame and receives the NFRP trigger frame with the AID12 set to the AID of the non-AP STA may transmit an NDP feedback set to true. If an AP receives the NDP feedback set to true from the non-AP STA, the AP may transmit a Basic trigger frame to trigger transmission of the low-latency frame from the non-AP STA.

In many example embodiments, the NFRP trigger frame includes an indication of that the NDP feedback is transmitted only for the non-AP STA's buffered low-latency frame.

In additional example embodiments, a non-AP STA that receives the NFRP trigger frame may respond with an NFRP response frame set to true and indicating additional LL packet delay information. For example, whether a HOL (head of line) packet enqueue time exceeds or does not exceed a certain threshold time (e.g. set a FEEDBACK_STATUS value to 0 indicating “exceeds” and to 1 indicating “does not exceed”, or vice-versa). In another example, whether a HOL packet expiration time is less than or larger than a certain threshold (e.g. a FEEDBACK_STATUS value 0 indicates “less than” and 1 indicates “larger than”, or vice-versa).

The thresholds mentioned above may be signaled in parameters that the non-AP STA gets during an association procedure (e.g. an NDP Feedback Report Parameter Set element) or the SCS procedure or in the NFRP trigger frame itself. Which option above is used can be signaled in the NFRP trigger frame or predefined in the specification.

Now presented is an example embodiment for defining the IEEE 802.11bn specification to include the new DSR information presented above in the NDP feedback is as follows; Add the following text “Table 26-xx-FEEDBACK_STATUS description for DSR.

FEEDBACK_STATUS set to 0 if: The STA is in the awake state and reports buffered octets for transmission not exceeding the delay threshold (e.g., HOL packet expiration time is larger than threshold). NOTE—The STA can use this value to indicate that it is in the awake state even if it does not have any buffered octets for transmission, e.g., to solicit delivery of Bus known to be buffered at the AP.

FEEDBACK_STATUS set to 1 if: The STA is in the awake state and reports buffered octets for transmission exceeding the delay threshold (e.g., HOL packet expiration time is less than threshold). The delay threshold is identified in the most recently received NDP Feedback Report Parameter Set element sent by the AP with which the STA is associated.

Generating a low-latency (LL) specific DSR using a BSRP (Buffer Status Report Poll) trigger frame

BSRP trigger frames are used for allocating resource units (RUs) to non-AP STAs. The BSRP trigger frame can also be used for allocating random access resource units (RA-RUs) to non-AP STAs that have BSR (buffer status report) information to be sent to the AP.

In order to generate a low-latency (LL) specific DSR from non-AP STAs that have buffered low-latency frames, the BSRP trigger frame may include a subfield indicating a poll of delay status report.

For example: a DSR Poll subfield (e.g., value 0 is reserved, value 1 indicates polling of delay status report). Then if the DSR Poll subfield is set to 1 and RA-RUs are allocated in the BSRP trigger frame, only non-AP STA that has buffered low-latency frames may transmit a QoS Null frame including the DSR information using one of allocated RA-RUs. A QOS Null frame without the DSR information (but with the BSR information) is not allowed to be transmitted on the allocated RA-RUs. If the DSR Poll subfield is set to 1 and the AID12 field indicates a non-AP STA specifically in the BSRP trigger frame, the non-AP STA may transmit a QoS Null frame including the DSR information using the allocated RU.

The BSRP trigger frame may include a subfield indicating a direction of the stream which DSR/BSR is associated with an AP transmit a BSRP trigger frame to collect a delay status for buffered LL frames from one or more non-AP STAs through the allocated RA-RU(s) or non-RA-RU(s).

In various example embodiments, a non-AP STA that receives the BSRP trigger frame generates a response frame including one or more QoS Null frame(s) including the requested delay status information using the allocated RA-RU(s) or non-RA-RU(s). The QoS null frame may include at least one of: a traffic identifier (TID); a head of line (HOL) packet delay; a queue size of the TID; or a direction information indicating an uplink or a direct link.

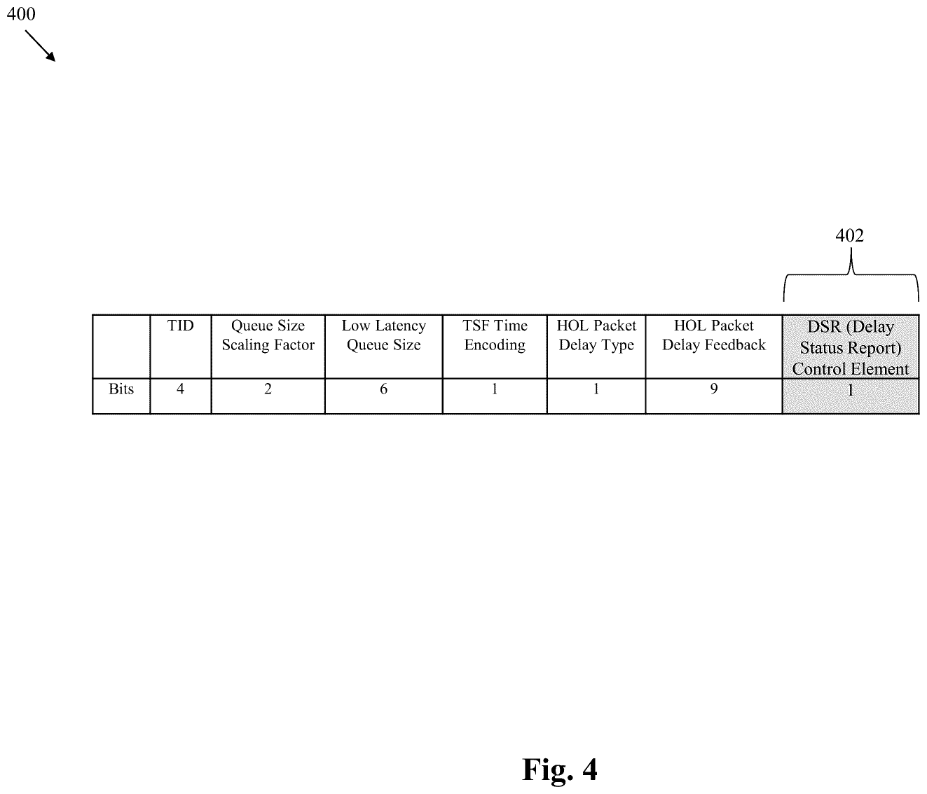

FIG. 4 represents a first example 400 of DSR control field in a DSR frame for reporting on buffered low-latency (LL) frames. In this example 400, the Direction subfield 402 indicates a direction of the traffic stream (e.g. an uplink (UL) to an AP, or a direct/P2P link with another non-AP STA) associated with the reported delay status information.

In some example embodiments, the AP trigger frame request is in the form of an MU-RTS TXS trigger frame, where for example both the non-AP STA and the AP have dot11EHTTXOPSharingTFOptionImplemented equal to true and the triggered TXOP Sharing Mode 2 Support subfield in the EHT Capabilities element set to 1.

The DSR frame containing the direction indication can be: in some example embodiments, a 1 bit indication (e.g., Direction subfield) can be added (e.g., 0 indicates uplink, and 1 indicates direct link); or in other example embodiments, a specific TID can be used to indicate direct link (e.g., TID 15 indicates direct link) and otherwise uplink

In many example embodiments, the non-AP STA may transmit the DSR frame (e.g., a QoS Null frame including the DSR control field) indicating the direct link with the delay status and the buffer status information about the buffered frames in a QoS Null frame.

An AP that receives the QoS Null frame including the DSR control field indicating the direct link may transmit an MU-RTS TXS trigger frame (or other control frame) to allocate a time period to the non-AP STA to use the direct link communication with its peer STA.

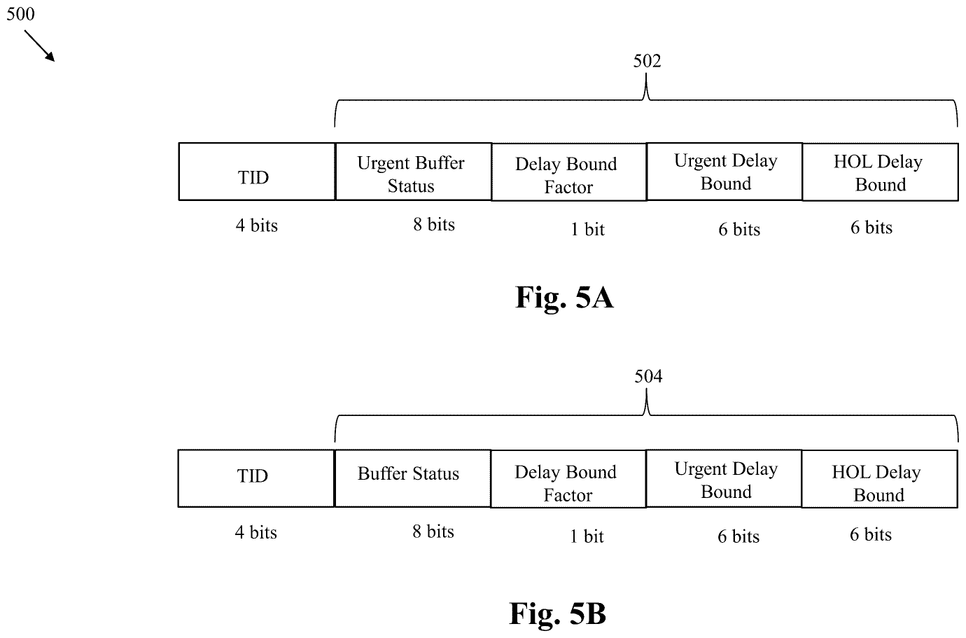

FIGS. 5A, 5B represents a second example 500 of a DSR control field 502, 504 in a DSR frame for reporting on buffered low-latency (LL) frames. In this example 500, the DSR control field 502, 504 from a non-AP STA include a set of delay bound subfields. The delay bound subfields represent a maximum acceptable transmission delay of one or more low-latency (LL) frames.

In some examples, if the set of delay bound elements includes a Delay bound Factor field, then at least two granularities can be indicated in the Delay bound Factor field (e.g. 512 us and 4 ms, or 1 ms and 8 ms).

If the set of delay bound subfields additionally includes a HOL Delay bound subfield (e.g. 5 or 6-bits), then the HOL Delay bound subfield can announce a delay bound of the TID indicated by TID subfield (i.e. a remaining time until the delay bound, or the TSF time of delay bound). Examples include: 256 us and 2 ms granularities, and a 5-bit HOL Delay bound subfield (e.g. 256 us to 8 ms, or 2 ms to 64 ms); or 512 us and 4 ms granularities, and a 5-bit HOL Delay bound subfield (e.g. 512 us to 16 ms, or 4 ms to 128 ms). Other granularities combinations are also possible.

In various example embodiments, the HOL Delay bound subfield carries a floor of a real delay bound of a HOL frame, or a ceil operation to fill HOL Delay bound subfield.

In other examples, if the set of delay bound subfields includes an urgent delay bound. The urgent delay bound can indicate a latest delay bound of the frames being included by a Buffer Status subfield. The latest delay bound is equal to urgent delay bound+HOL Delay bound with the granularities indicated by Delay bound Factor subfield. The urgent delay bound subfield carries the floor of the real latest delay bound with floor (urgent delay bound)−the value in urgent delay bound subfield. The Buffer Status includes 2-bit Buffer Status Factor, and 6-bit Buffer Status information. For example, the Buffer Status Factor can define 4 granularities: 16, 256, 2048, 32768. The whole buffer size of the TID is announced in QoS Control field.

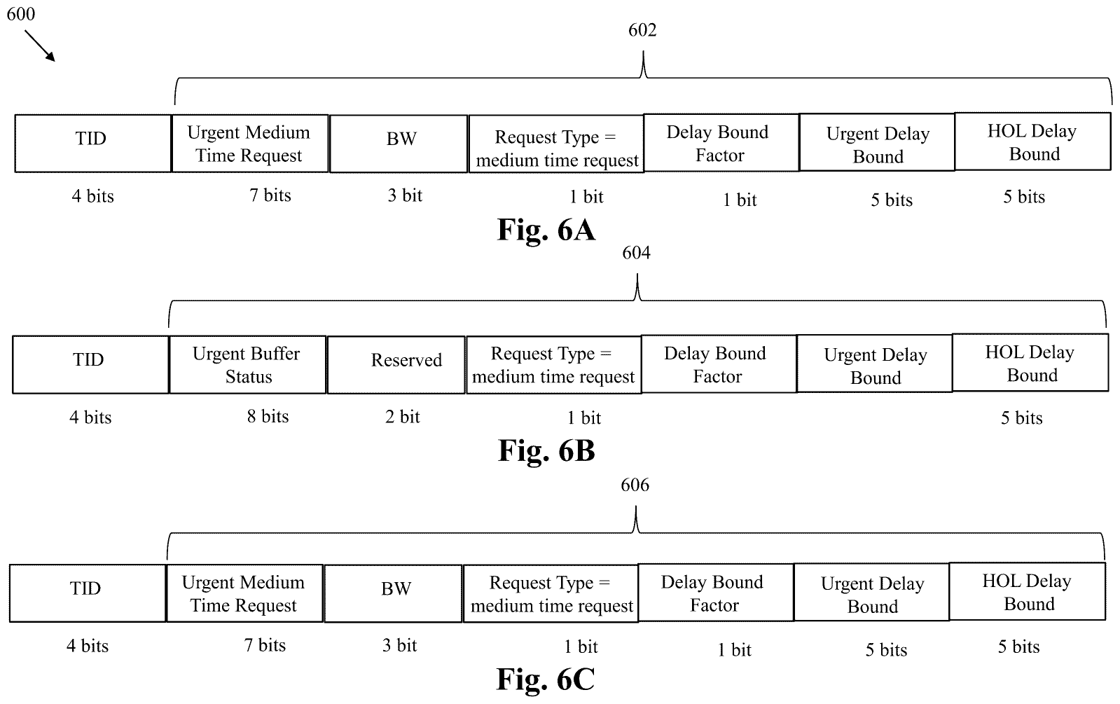

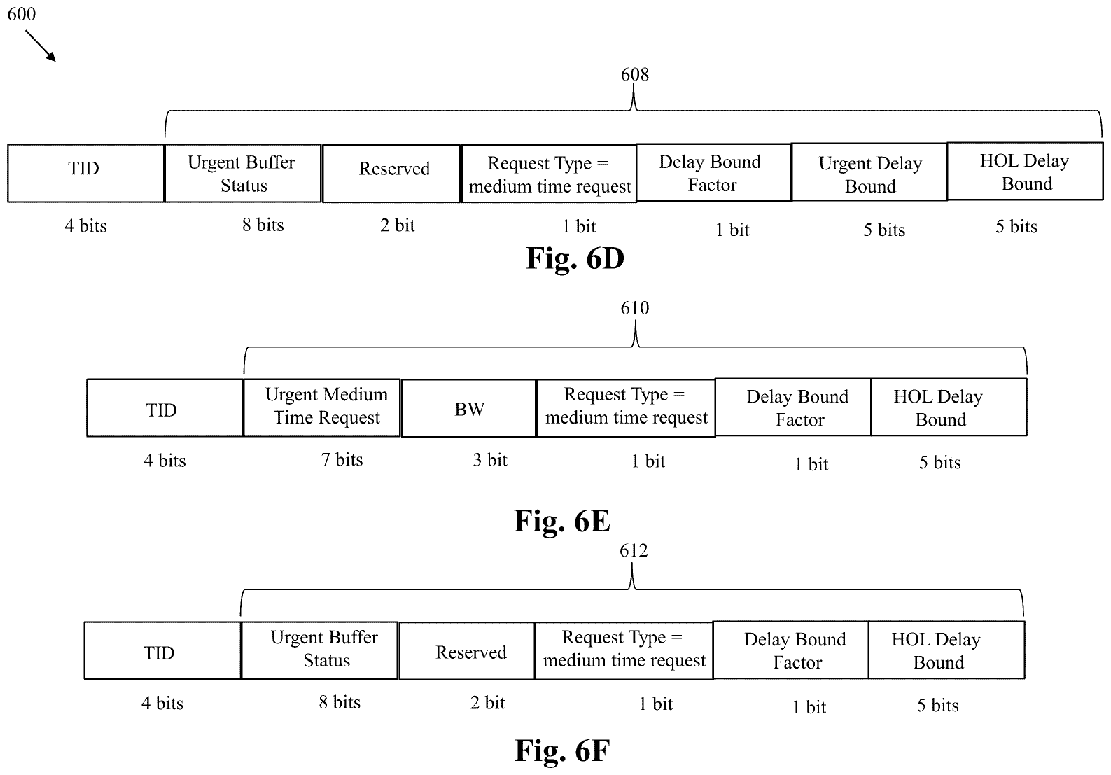

FIG. 6A, 6B, 6C, 6D, 6E, 6F represents a third example 600 of a set of DSR control field 602, 604, 606, 608, 610, 612 in a DSR frame for reporting on buffered low-latency (LL) frames. In this example 600, the DSR control field 602, 604, 606, 608, 610, 612 from a non-AP STA include a medium time request subfield.

The medium time request subfield requests a medium time whose delay bound are not more than an urgent delay bound+HOL Delay bound, with granularity defined by Delay bound Factor if a Request Type indicates the request of medium time.

In some example embodiments, the medium time request includes a one-bit granularity subfield medium time info field. For example, the Granularity subfield can indicate two granularities, 128 us and 512 us. If the granularity is under 128 us, then the request medium time is from 32 us to 2048 us. If the granularity is under 512 us, then the request medium time is from 128 us to 8096 us. A BW (bandwidth) subfield indicates a bandwidth under which medium time is requested, (e.g. 20 MHz, 40 MHz, 80 MHz, 160 MHz, 320 MHz).

When medium time or buffer status request use a same Control ID value, then the Request Type can indicate whether the medium time or buffer status is carried in the HE Control field. However, when the buffer status request and the medium time request use the separate Control ID values, then the request type field is not needed.

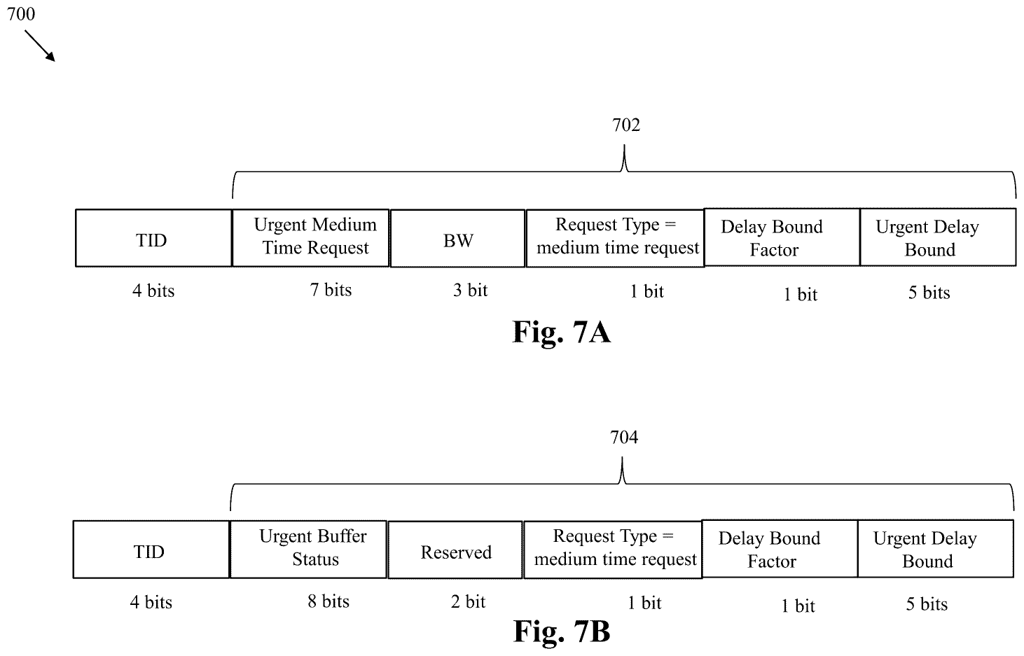

FIGS. 7A, 7B represents a fourth example 700 of a set of DSR control field 702, 704 in a DSR frame for reporting on buffered low-latency (LL) frames. In this example 700, the DSR control field 702, 704 from a non-AP STA only defines an urgent delay bound. In response, the AP allocates Resource Unit (RU) medium time and RU bandwidth (BW) to the non-AP STA that requested the RUs based on the HOL Delay bound, urgent delay bound, the size of buffered frames, and the request medium time+BW.

Various instructions and/or operational steps discussed in the above Figures can be executed in any order, unless a specific order is explicitly stated. Also, those skilled in the art will recognize that while some example sets of instructions/steps have been discussed, the material in this specification can be combined in a variety of ways to yield other examples as well, and are to be understood within a context provided by this detailed description.

In some example embodiments these instructions/steps are implemented as functional and software instructions. In other embodiments, the instructions can be implemented either using logic gates, application specific chips, firmware, as well as other hardware forms.

When the instructions are embodied as a set of executable instructions in a non-transitory computer-readable or computer-usable media which are effected on a computer or machine programmed with and controlled by said executable instructions. Said instructions are loaded for execution on a processor (such as one or more CPUs). Said processor includes microprocessors, microcontrollers, processor modules or subsystems (including one or more microprocessors or microcontrollers), or other control or computing devices. A processor can refer to a single component or to plural components. Said computer-readable or computer-usable storage medium or media is (are) considered to be part of an article (or article of manufacture). An article or article of manufacture can refer to any manufactured single component or multiple components. The non-transitory machine or computer-usable media or mediums as defined herein excludes signals, but such media or mediums may be capable of receiving and processing information from signals and/or other transitory mediums.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

What is claimed is:

1. A method of low-latency (LL) frame management for communications between a first WLAN (wireless local area network) device and a second WLAN device, comprising:
transmitting, by the first WLAN device, a low-latency (LL) specific delay status report (DSR) trigger frame to the second WLAN device; and
receiving, by the AP, a DSR frame from the second WLAN device in response to the LL specific DSR trigger frame.

2. The method of claim 1:
wherein the first WLAN device is an AP (access point) and the second WLAN device is a non-AP STA (station).

3. The method of claim 1:
wherein the second WLAN device is a non-AP STA configured for direct peer-to-peer (P2P) communication with another non-AP STA.

4. The method of claim 2:
wherein the LL specific DSR trigger frame is a modified NFRP (NDP Feedback Report Poll) trigger frame.

5. The method of claim 4:
wherein the NFRP trigger frame includes an AID12 subfield set to a specific value or to an AID of the non-AP STA; and
wherein if the non-AP STA has buffered LL frames, then the non-AP STA is configured set the DSR frame to true in response to the AID12 subfield set to the specific value or set to the AID of the non-AP STA.

6. The method of claim 4:
wherein the non-AP STA is configured to include an indication whether a HOL (head of line) packet enqueue time exceeds or does not exceed a certain threshold time in the DSR frame.

7. The method of claim 4:
wherein the non-AP STA is configured to include an indication whether a HOL (head of line) packet expiration time is less than or larger than a certain threshold in the DSR frame.

8. The method of claim 2:
wherein the LL specific DSR trigger frame is a BSRP (Buffer Status Report Poll) trigger frame.

9. The method of claim 8:
wherein the non-AP STA is configured to indicate a presence of buffered LL frames in the DSR frame; and
wherein the AP is configured to allocate a set of resource units (RUs) to the non-AP STA for transmission of the buffered LL frames.

10. The method of claim 8:
wherein the BSRP trigger frame includes a subfield indicating a poll of delay status report for prompting the non-AP STA to indicate the presence of buffered LL frames.

11. The method of claim 8:
wherein the BSRP trigger frame includes a subfield indicating a direction of a traffic stream for prompting the non-AP STA to indicate a direction of the buffered LL frames.

12. The method of claim 8:
wherein the DSR frame from the non-AP STA includes a QoS (quality of service) Null frame; and
wherein the QoS Null frame includes delay status information on the buffered LL frames.

13. The method of claim 8:
wherein the QoS null frame includes at least one of: a traffic identifier (TID); a head of line (HOL) packet delay; a queue size of the TID; or a direction information indicating an uplink or a direct link.

14. The method of claim 1:
further comprising adding a DSR control field to the DSR frame for reporting on buffered low-latency (LL) frame.

15. The method of claim 14:
wherein the DSR control field includes an indication of a direction of a traffic stream associated with reported delay status information.

16. The method of claim 14:
wherein the set of DSR control field is embedded in a QoS (quality of service) Null frame.

17. The method of claim 14:
wherein the DSR control field includes a set of delay bound subfields.

18. The method of claim 14:
wherein the DSR control field includes a medium time request subfield.

19. The method of claim 14:
wherein the DSR control field includes an urgent delay bound.

20. The method of claim 1:
wherein the DSR frame includes a control field for indicating whether the non-AP STA's buffered LL frames are uplink (UL) frame or direct/P2P link frames.

21. An access point (AP) configured to communicate over a WLAN (wireless local area network) network, comprising:
a controller configured to transmit a low-latency (LL) specific delay status report (DSR) trigger frame requesting a DSR frame from a non-AP STA over the WLAN network; and
wherein the controller is further configured to receive the DSR frame from the non-AP STA.
